(19) United States
(12) Patent Application Publication
(10) Pub. No.: US 2011/0051923 A1
(43) Pub. Date: Mar. 3, 2011

(54) METHOD, DEVICE, AND COMPUTER-READABLE STORAGE MEDIUM FOR PRODUCING DIGITAL SIDE TONE

(75) Inventor: Ramachandra ARAVIND BATNI, Germantown, MD (US)

(73) Assignee: TEXAS INSTRUMENTS INCORPORATED, Dallas, TX (US)

(21) Appl. No.: 12/549,771

(22) Filed: Aug. 28, 2009

(51) Int. Cl. H04M 9/00

(52) U.S. Cl. 379/391

(57) ABSTRACT

A method, device, and computer-readable storage medium for providing digital side tone are disclosed. These embodiments are directed toward processing digital side tone in a secondary processing unit external to a primary processing unit that includes the main digital signal processor, thereby reducing delay in producing side tone and freeing up processing resources in the primary processing unit. In an environment where the sampling rate of a digital-to-analog converter in the secondary processing unit is an integer multiple of the sampling rate of an analog-to-digital converter in the secondary processing unit, the components of the secondary processing unit are made to operate such that the digital side tone signal and the main tone signal are equal in sampling frequency and number of samples.

### TECHNICAL FIELD

The present application relates to the production of digital side tone. Digital side tone is known in the art as sound received in a communication device mouthpiece and reintroduced at a lower decibel level in an earpiece or speaker of the same communication device. Digital side tone is a form of feedback.

### BACKGROUND

Efficient and appropriate processing of digital side tone in communication devices is an important issue. If digital side tone is not provided, a user of a communication device will not hear his voice in the earpiece during communications. This gives the user the sensation that the device is not working. To the contrary, too much digital side tone can create listening discomfort which may cause the user to unnecessarily lower his voice. Conventional communication devices typically process digital side tone internally in a main digital signal processor (DSP). However, a digital side tone implementation in a secondary processing unit external to the DSP, such as an Analog Interface Codec (AIC) including an analog-to-digital converter (ADC) and digital-to-analog converter (DAC), is a more intelligent system design. Such an implementation would minimize the delay in production of the digital side tone, as an AIC is earlier in a processing path when compared with a main DSP. Digital side tone implementation in an AIC further reduces the use of processing resources in the main DSP and relieves the main DSP of performing the digital side tone task.

### SUMMARY

Embodiments described herein improve upon prior art digital side tone processing by performing digital side tone processing in a secondary processing unit external to a primary processing unit, the secondary processing unit including an ADC, a DAC, a sample buffer, and a mixer. Accordingly, a first embodiment described herein provides a method for producing digital side tone that includes reading “X” samples output from a digital decimator at a rate equal to an output sampling rate of a first interpolator, storing the “X” read samples in a sample buffer, and outputting the “X” read samples as “X” digital side tone samples to the DAC. The method further comprises decimating, in a first decimator, “k·X” samples stored in the sample buffer by a factor “k”, and outputting “X” yielded samples to a second decimator. In the second decimator, the “X” yielded samples are decimated, and a single sample is output to the primary processing unit at a rate equal to the sampling frequency of samples input to the DAC. In the primary processing unit, “k−1” samples are discarded for every “k” samples read by the primary processing unit. In the sample buffer, the “k·X” samples stored in the sample buffer are continually shifted by a factor “X” thereby accommodating additional sets of “X” samples read from the digital decimator per frame. In the first interpolator, a single sample received from the primary processing unit is interpolated by a factor “X” and “X” interpolated samples are output. In the DAC, the “X” interpolated samples are mixed with the “X” digital side tone samples, and “X” side tone mixed samples are output. In the method, the ADC is configured with the digital decimator, the first decimator and the second decimator, and the DAC is configured with the first interpolator. Further, the sampling frequency of samples input to the DAC are an integer multiple “k” of a sampling frequency of samples read from the ADC and “X” is the decimator factor of the second decimator

A second embodiment described herein provides a communication device capable of producing digital side tone that comprises a transceiver, a primary processing unit cooperatively operable with the transceiver and configured for performing communication functions, and a secondary processing unit cooperatively operable with the primary processing unit. The secondary processing unit includes an ADC configured with a first decimator and a second decimator, a DAC configured with a first interpolator, a sample buffer of length “k·X”, and a mixer. In the secondary processing unit, a sampling frequency of samples input to the DAC is an integer multiple “k” of a sampling frequency of samples read from the ADC, and “X” is the decimator factor of the second decimator. The ADC is further configured with a digital decimator that outputs “X” samples at a rate equal to an output sampling rate of the first interpolator. The “X” read samples are stored in the sample buffer, and are also are output as digital side tone samples to the DAC. The ADC is configured so that the first decimator decimates “k·X” samples stored in the sample buffer by a factor “k” and outputs “X” yielded samples to the second decimator. The ADC is configured so that the second decimator decimates the “X” yielded samples and outputs to the primary processing unit a single sample at a rate equal to the sampling frequency of samples input to the DAC. The primary processing unit is configured to discard “k−1” samples for every “k” samples it reads from the second decimator. The sample buffer is configured to continually shift the “k·X” samples stored in the sample buffer by a factor “X” thereby accommodating additional sets of “X” samples read from the digital decimator per frame. The DAC is configured so that the first interpolator interpolates a single sample received from the primary processing unit by a factor “X” and outputs “X” interpolated samples. Finally, the mixer is configured to mix the “X” interpolated samples with the “X” digital side tone samples and to output the results as “X” side tone mixed samples.

A third embodiment described herein describes a computer-readable storage medium comprising instructions for execution by a processor. The instructions include a processor-implemented method for providing digital side tone in a communication device with a primary processing unit and a secondary processing unit. The instructions implement reading “X” samples output from a digital decimator at a rate equal to an output sampling rate of a first interpolator, storing the “X” read samples in a sample buffer, and outputting the “X” read samples as “X” digital side tone samples to a digital-to-analog converter (DAC). The instructions further implement decimating, in a first decimator, “k·X” samples stored in the sample buffer by a factor “k”, and outputting “X” yielded samples to a second decimator. The instructions next implement decimating, in the second decimator, the “X” yielded samples, and outputting to the primary processing unit a single sample at a rate equal to the sampling frequency of samples input to the DAC. The instructions additionally implement discarding “k”−1 samples for every “k” samples read by the primary processing unit, and continually shifting the “k·X” samples stored in the sample buffer by a factor “X” thereby accommodating additional sets of “X” samples read from the digital decimator per frame. The instructions further implement interpolating, in a first interpolator, a single sample received from the primary processing unit by a factor “X” and outputting “X” interpolated samples. The instructions lastly implement mixing, in a mixer, the “X” interpolated samples with the “X” digital side tone samples, and outputting the results as “X” side tone mixed samples. In the computer-implemented method, the secondary processing unit includes an ADC configured with the digital decimator, the first decimator and the second decimator, the DAC configured with the first interpolator, the sample buffer of length “k·X”, and the mixer. Additionally, the sampling frequency of samples input to the DAC is an integer multiple “k” of a sampling frequency of samples read from the ADC and “X” is the decimator factor of the second decimator.

### BRIEF DESCRIPTION OF THE DRAWINGS

The accompanying figures where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a diagram illustrating a secondary processing unit in an exemplary communication device for providing digital side tone, the secondary processing unit including and ADC, a DAC, a sample buffer, and a mixer.

FIG. 2 is a diagram illustrating a sample buffer in a secondary processing unit of an exemplary communication device, the sample buffer storing audio samples.

FIG. 3 is a flow chart illustrating an exemplary method of providing digital side tone.

FIG. 4 is a block diagram illustrating an exemplary communication device for providing digital side tone.

FIG. 5 is a diagram illustrating a related ADC in a secondary processing unit of a communication device.

FIG. 6 is a diagram illustrating a related DAC in a secondary processing unit of a communication device.

### DETAILED DESCRIPTION

As further discussed herein below, various inventive principles and combinations thereof are advantageously employed to more efficiently process digital side tone. The instant disclosure (including the entirety of the drawings and the entirety of this specification, including the abstract) is provided to further explain in an enabling fashion the best modes of performing one or more embodiments. The disclosure is further offered to enhance an understanding and appreciation for the novel principles and advantages associated with said embodiments. The disclosure is not intended to be limiting in any manner, and the invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

As mentioned above, the present disclosure concerns providing digital side tone in communication devices. Such communication devices include digital wireless communications devices, such as cellular phones or two-way radios and the like associated with a communication system such as an Enterprise Network, a cellular Radio Access Network, or the like. Such communication systems may further provide services such as voice and data communications services. Additionally, the present disclosure concerns digital landline communication devices operating over the publicly switched telephone network (PSTN).

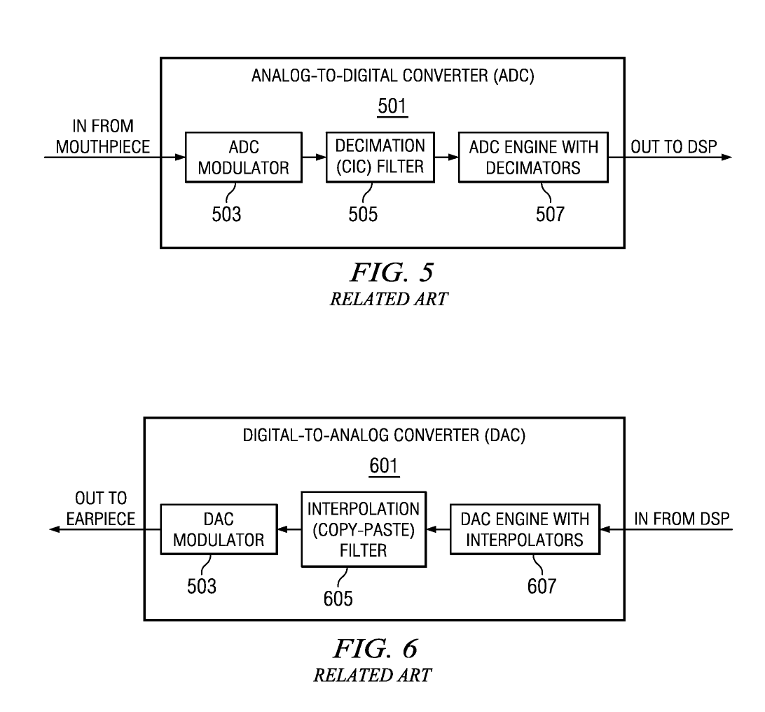

In order to more clearly understand the novel and inventive features of the exemplary embodiments described herein, a brief discussion of a related ADC and DAC in a secondary processing unit operable in a communication device is helpful. Referring then to FIG. 5, a diagram illustrating a related ADC in a secondary processing unit is discussed and described. An ADC 501 includes an ADC modulator 503, a decimation cascaded integrator-comb (CIC)) filter 505, and an ADC engine 507 with one or more decimators. The ADC modulator 503 is a delta-sigma modulator with a programmable over sampling ratio (OSR), and the CIC decimation filter 505 is an integrated digital decimation filter that removes high-frequency content and downsamples the audio data from the initial sampling rate of the ADC modulator 503. The CIC decimation filter 505 is an exemplary filter in that a decimator is built into the architecture. It is understood that other related ADCs implement a filter and decimator separately and/or contemplate a plurality of other available filters. The ADC engine 507 further includes one or more additional decimators that downsample the audio data to the sampling rate of the ADC where a signal sample per frame is output to the DSP. The ADC supports an output sampling rate to the DSP of between 8 kHz and 192 kHz, and as is understood in the art, the ADC modulator has an initial sampling rate that is the product of the OSR of the ADC modulator and the ADC sampling rate.

Referring next to FIG. 6, a diagram illustrating a related DAC in a secondary processing unit is discussed and described. The DAC 601 includes a DAC modulator 603, an interpolation (copy-paste) filter 605, and a DAC engine 607 with one or more interpolators. The DAC modulator 603 is a delta-sigma modulator with a programmable OSR that upsamples audio data from the copy-paste interpolator 605. The copy-paste interpolator 605 is an exemplary interpolator and it is understood that other related DACs contemplate a plurality of available filters and interpolators. The copy-paste interpolator 605 upsamples the audio data from the ADC engine 607 that further includes one or more additional interpolators that upsample a single sample from the DSP at a DAC sampling rate, where the final sampling rate of the DAC modulator 607 is the product of the OSR of the DAC modulator 607 and the DAC sampling rate. The DAC supports a sampling rate in from the DSP of between 8 kHz and 192 kHz.

It should be noted that the ADC engine 507 and the DAC engine 607 operate on the principle that a multiple stage decimation or interpolation achieves better results. However, limited instruction space is a constraint on the number of possible stages such that the ADC engine 507 is commonly configured with two decimators and the DAC engine 607 is similarly configured with two interpolators. As understood in the art, the number of samples processed per frame by both the ADC engine 507 and DAC engine 607 is a function of the values set as the decimating and interpolating factors in the respective decimators and interpolators in the respective engines.

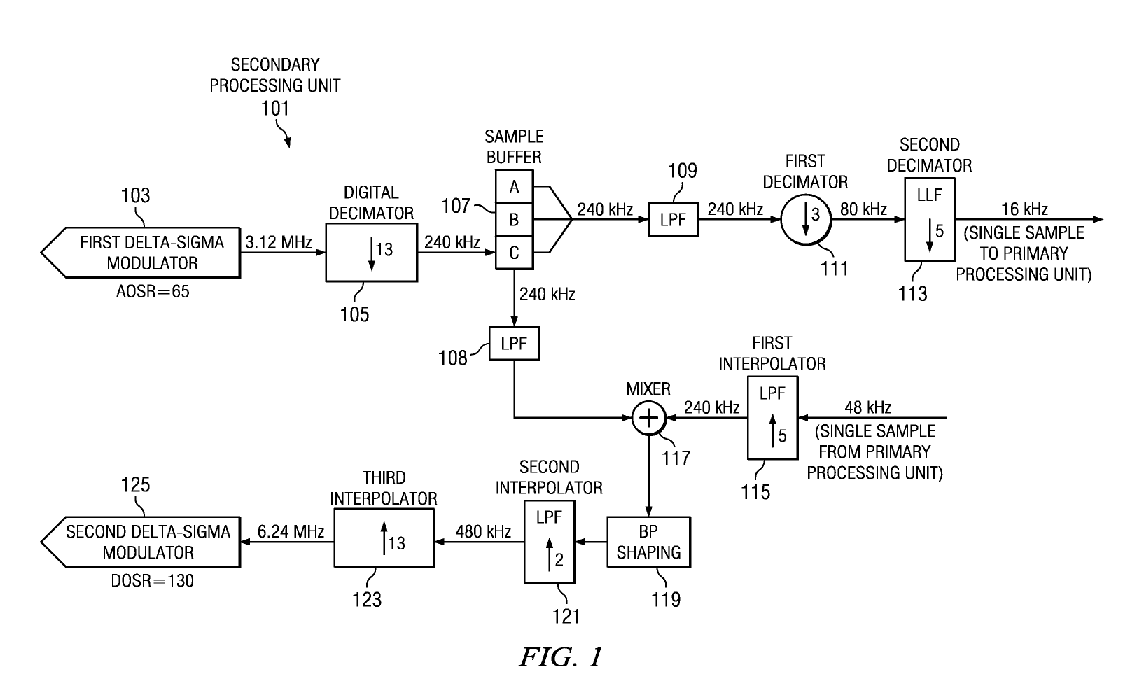

In view of the operation of the ADC 501 and DAC 601, and as discussed in detail below, the various inventive principles and combinations thereof are advantageously employed to reduce delay in producing digital side tone and to additionally free the main DSP of digital side tone processing. As a result, the DSP is available to perform additional processing functions. Referring then to FIG. 1, a diagram illustrating a secondary processing unit in an exemplary communication device for providing digital side tone, the secondary processing unit including an ADC, a DAC, a sample buffer, and a mixer, will now be discussed and described.

FIG. 1 illustrates a secondary processing unit 101 to be used in communication device for providing digital side tone. The secondary processing unit 101 may include a first delta-sigma modulator 103, a digital decimator 105, a sample buffer 107, a low-pass filter (LPF) 109, a first decimator 111, a second decimator 113, an LPF 108, a first interpolator 115, a mixer 117, a band pass (BP) shaping unit 119, a second interpolator 121, a third interpolator 123, and a second delta-sigma modulator 125.

It should be understood that the first delta-sigma modulator 103, the digital decimator 105, the first decimator 111, and the second decimator 113 are components that resemble the ADC 501. The first decimator 111 and the second decimator 113 further resemble the decimator components of the ADC engine 507. It should additionally be understood that the first interpolator 115, the second interpolator 121, the third interpolator 123, and the second delta-sigma modulator 125 are components that resemble the DAC 601. The first interpolator 115 and the second interpolator 121 further resemble the interpolator components of the DAC engine 607. The components 103-113 (excluding the sample buffer 107 and LPF 108) are hereinafter referred to in this discussion of FIG. 1 simply as “the exemplary ADC.” The components 115-125 (excluding the mixer 117) are hereinafter referred to in this discussion of FIG. 1 simply as “the exemplary DAC.” The sampling rate out of the exemplary ADC (as illustrated in FIG. 1 to the right of the second decimator 113) is referred to as “the exemplary ADC sampling rate” and the sampling rate in to the exemplary DAC (as illustrated in FIG. 1 to the right of the first interpolator 115) is referred to as “the exemplary DAC sampling rate.”

A digital side tone implementation in the secondary processing unit 101 is achieved by mixing the digital side tone with the main tone at some particular point in the processing path. It is desirable that the digital side tone response should be different than the main tone output from a DSP in a primary processing unit. Thus the best place to sum the digital side tone is at a point immediately after the first interpolator 115. Thus as is seen in FIG. 1, the mixer 117 receives input from the first interpolator 115 and from Block C of the sample buffer 107. As will be discussed below, samples stored in block C of the sample buffer 107 are digital side tone samples downsampled from the first delta-sigma modulator 103 and the digital decimator 105.

A key concept in mixing the digital side tone with the main tone is that wherever in the processing path the mixing occurs, the sampling frequency of the digital side tone and the sampling frequency of the main tone must be equal. Additionally the number of digital side tone samples and the number of main tone samples must be equal. In a nutshell, there must be synchronization in the sampling frequencies and number of samples of the digital side tone and the main tone.

When the exemplary DAC sampling rate is an integer multiple “k” greater than the exemplary ADC sampling rate, there is conventionally no way to achieve synchronization in sampling rate and number of samples so as to add the digital side tone with the main tone. Thus the novel method, device, and computer-readable medium disclosed and claimed herein are designed for an environment such as that illustrated in FIG. 1 where the exemplary DAC sampling rate is 3 (that is, the integer multiple “k”=3) times greater than the exemplary ADC sampling rate. Specifically, the exemplary DAC sampling rate in FIG. 1 is 48 kHz and the exemplary ADC sampling rate is 16 kHz. It should be expressly noted that FIG. 1 present only a single example of the many different possible assignments of sampling rates and as other variables such as decimation factors, interpolation factors, OSRs, and the like.

In order to achieve a synchronization between the exemplary ADC and the exemplary DAC with respect to sampling frequency and number of samples, the exemplary ADC sampling rate must be effectively be made to equal the exemplary DAC sampling rate. This essentially means that the exemplary ADC is programmed to run “k” times faster than expected. That is to say, the exemplary ADC is clocked to output samples “k” times faster than under normal operating conditions. The effect is that the exemplary ADC outputs a sample to the primary processing unit at a 48 kHz rate, such that the exemplary ADC yields “k−1” redundant samples to a primary processing unit. Therefore the primary processing unit is programmed so as to discard “k−1” samples for every “k” samples read.

In the secondary processing unit 101, the values of the decimators, interpolators, the OSRs, and the like are programmed so as to achieve the synchronicity described above given the exemplary ADC sampling rate and the exemplary DAC sampling rate. Specifically, the decimation factor of the first decimator 111 is set to the value of “k,” which in this example is 3 as is illustrated by a downward arrow with the number 3 adjacent to the arrow in the middle of the circle that represents the first decimator 111. The value of the decimation factor of the second decimator 113 is then set which is this example is 5, as is illustrated by a downward arrow with the number 5 adjacent to the arrow in the middle of the square that represents the second decimator 113. This second decimation value is referred to hereinafter as “X”. In summary, the first decimator 111 is set to “k” and the second decimator is set to “X”. The second decimator in this example is also seen to be low latency filter (LLF), but this is not universally true of all secondary processing units in accord with the inventive principles described herein.

The interpolation factor of the first interpolator 115 is also set to “X”. The assignments to remaining variables in the secondary processing unit 101 are as follows: the OSR of the first delta-sigma modulator 103 (AOSR) is set to 65; the decimation factor of the digital decimator is set to 13; the interpolation factor of the second interpolator 121 is set to 2; the interpolation factor of the third interpolator is set to 13; and the OSR of the second delta-sigma modulator 125 (DOSR) is set to 130.

Turning then to the details of the second processing unit 101, the first delta-sigma modulator 103 outputs samples at 3.12 MHz. Thus, 65 samples per frame are output at 3.12 MHz. The digital decimator 105 then decimates the audio samples by 13, resulting in 5 samples being output from the digital decimator 105 at a sampling rate of 240 kHz (3.12 MHz÷13). The 5 output samples are stored in Block C of the sample buffer 107 and are simultaneously output through LPF 108 to the mixer 117.

It should be noted that the number of samples output by the digital decimator 105 is equal to “X”, and the AOSR is set such that “X” samples are output from the digital decimator 105. The total size of the sample buffer 107 is “k·X” samples, there being “k” blocks of “X” samples. Thus in the example of FIG. 1, the sample buffer 107 has 3 blocks, each block having 5 samples, the sample buffer 107 being capable of storing a total of 15 (that is, 3·5) samples.

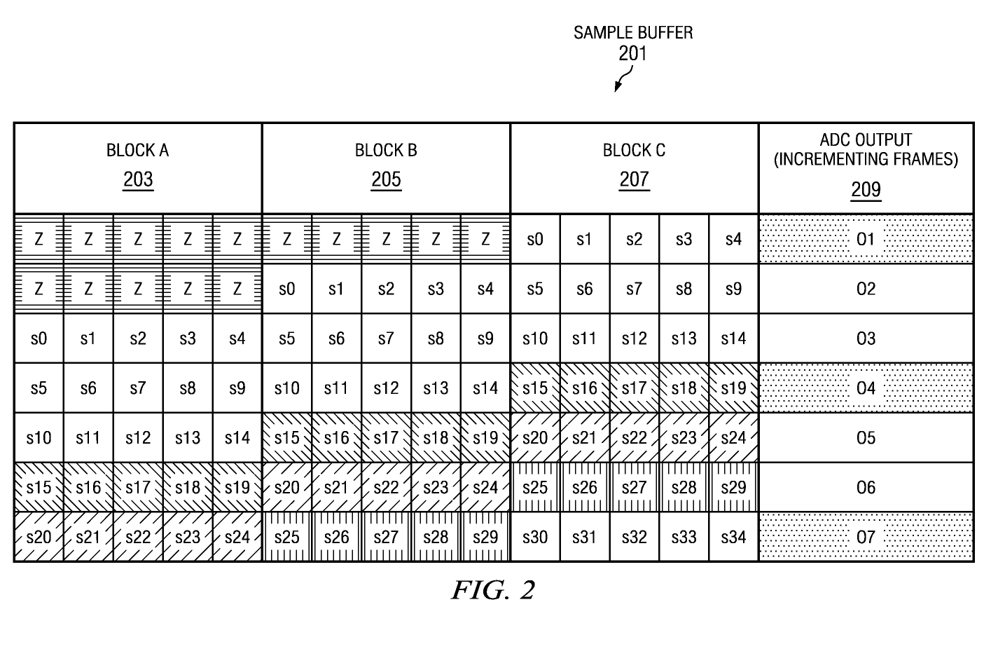

Block C always receives the “X” samples output from the digital decimator 105 in the current frame, and the “k·X” samples are shifted by “X” samples (that is, by a factor of “X”) every frame. Thus in the example of FIG. 1, block C always stores the 5 samples output from the digital decimator 105 in the current frame. Although there are dummy values (indicated in FIG. 2 as the boxes with “Z” values) initially stored in blocks B and C, after the first two frames the 15 samples stored in the sample buffer 107 are shifted by 5 samples (that is by a factor of 5) every frame.

Referring then to FIG. 2, a diagram illustrating a sample buffer in a secondary processing unit of an exemplary communication device, the sample buffer storing audio samples, is now described. The sample buffer 201 includes Block C 207, Block B 205, Block A 203, and ADC Output 209. As the sample buffer 201 features 3 blocks and each block stores 5 samples, it can be deduced that “k=3” and “X=5”. Further, where “X=5”, Block C stores 5 samples from the current frame. As described above, for every frame, with the exception of the first two frames, the 15 (“k·X”) samples stored in the sample buffer 201 are shifted by 5 (“X”) samples thereby accommodating additional sets of 5 (“X”) samples read from a digital decimator. The above described shifting is easily seen, for example by looking at samples s15, s16, s17, s18, and s19. The row identified by ADC Output O4 is considered the current frame. Thus samples s15, s16, s17, s18, and s19 are stored in Block C indicating that these samples are output by the digital decimator 105 at the current frame. In the next frame, indicated by ADC Output O5, samples s15, s16, s17, s18, and s19, as well as the remaining 10 samples (s5-s14) on the row identified by ADC Output O4, are shifted by 5 samples. Thus samples s15, s16, s17, s18, and s19 are shifted to Block B, samples s10, s11, s12, s13, and s14 are shifted to Block A, and samples s5, s6, s7, s8, and s9 are shifted out of the sample buffer 201 entirely. Samples s20, s21, s22, s23, and s24 output by the digital decimator 105 in the current frame and are stored in Block C.

In the next frame, indicated by ADC Output O6, samples s15, s16, s17, s18, and s19, as well as the remaining 10 samples (s10-s14 and s20-s24) on the row identified by ADC Output O5, (s10-s14 and s20-s24) are shifted by 5 samples. Thus samples s15, s16, s17, s18, and s19 are shifted to Block A, samples s20, s21, s22, s23, and s24 are shifted to Block B, and samples s10, s11, s12, s13, and s14 are shifted out of the sample buffer 201 entirely. Samples s25, s26, s27, s28, and s29 are output by the digital decimator 105 in the current frame and are stored in Block C. Samples s25, s26, s27, s28, and s29 undergo the same type of shifting described above, and this type of shifting of the “k·X” samples stored in the sample buffer 201 is continual. In FIG. 2, differentiating line marks are provided to illustrate how the samples are shifted.

Returning now to the description of FIG. 1, it was previously stated that the 5 samples output from the digital decimator 105 are output through LPF 108 to the mixer 117. The sampling frequency of the 5 samples is 240 kHz. The samples stored in Blocks C, B, and A are filtered through LPF 109 at sampling frequency of 240 kHz, but are subsequently downsampled by the first decimator 111 that outputs 5 samples (i.e., 15÷3) at a sampling frequency of 80 kHz (240 kHz÷3). The 5 samples output by the first decimator 111 are downsampled a final time by the second decimator 113 by a factor “X”, in this instance 5. Thus a single sample (5÷5) is output at a sampling frequency of 16 kHz (80 kHz÷5).

As discussed above, the exemplary ADC is clocked to output samples “k” times faster than under normal operating conditions. In FIG. 1, the ADC thus outputs samples at 48 kHz (16 kHz·3). However, because the primary processing unit only reads the samples at 16 kHz, it is programmed to discard 2 samples for every 3 samples read, and because the signal is already tuned within the secondary processing unit, there are no resulting aliasing effects.

The primary processing unit reads samples from the sample buffer 201 at modulo 3. That is to say, because 2 of every 3 samples are discarded, the read samples occur at every third output frame. Thus the samples are read from ADC Outputs (O1, O4, O7, etc), or from ADC Outputs (O2, O5, etc), or from ADC Outputs (O3, O6, etc). This is demonstrated in FIG. 2 with shading in ADC Outputs O1, O4, and O7.

Turning to the exemplary DAC, a single sample is read from the primary processing unit at a sampling frequency of 48 kHz. The single sample is upsampled by the first interpolator 115 by a factor “X” which in this instance is 5. Thus 5 samples (1·5) are output by the first interpolator 115 at a sampling frequency of 240 kHz (48 kHz·5) to the mixer 117. The mixer 117 thus mixes the 5 digital side tone samples output from Block C of the sample buffer 107 with 5 main tone samples output from the first interpolator 115. Indeed, the sampling frequency of both the digital side tone samples and the main tone samples is 240 kHz. Synchronization in both number of samples and sampling frequency is achieved.

Next, 5 mixed side tone samples are output from the mixer 117 to a BP shaping filter 119 for signal shaping at a sampling frequency of 240 kHz. The shaped mixed side tone samples are then upsampled by a second interpolator 121 by a factor 2. Thus 10 samples (5·2) are output from the second interpolator at a sampling frequency of 480 kHz (240 kHz·2). The third interpolator 123 upsamples the 10 mixed side tone samples by a factor 13, thereby outputting 130 mixed side tone samples (10·13) at a sampling frequency of 6.24 MHz (480 kHz·13). Theses final 130 samples are read by the second delta-sigma modulator 125 and output to the earpiece or communication device speaker. A successful implementation of digital side tone in the secondary processing unit 101 occurs.

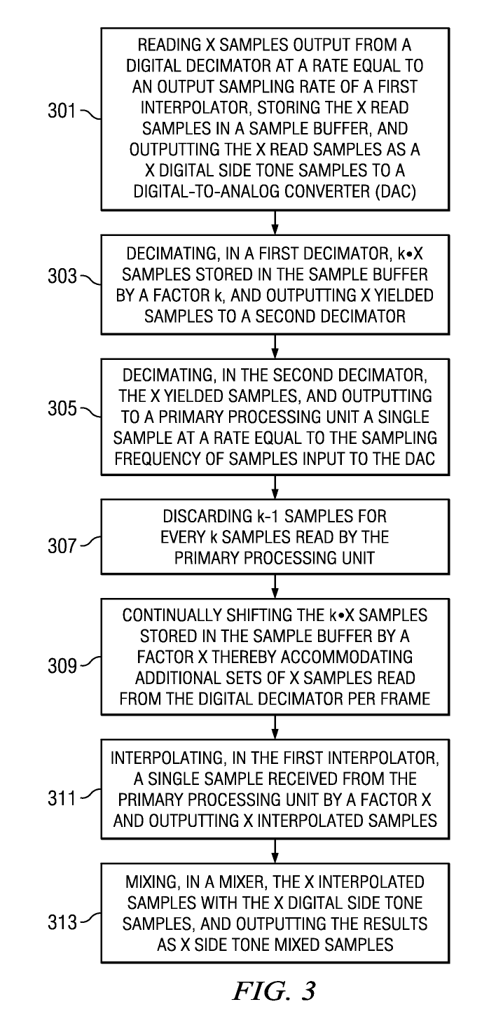

Referring now to FIG. 3, a flow chart illustrating an exemplary method of providing digital side tone is now described and discussed. At box 301, the method includes reading X samples output from a digital decimator at a rate equal to an output sampling rate of a first interpolator, storing the X read samples in a sample buffer, and outputting the X read samples as X digital side tone samples to a digital-to-analog converter (DAC). At box 303, the method includes decimating, by a first decimator, k·X samples stored in the sample buffer by a factor k, and outputting X yielded samples to a second decimator. At box 305, the method includes decimating, by the second decimator, the X yielded samples, and outputting to a primary processing unit a single sample at a rate equal to the sampling frequency of samples input to the DAC. At box 307, the method includes discarding k−1 samples for every k samples read by the primary processing unit. At box 309, the method includes continually shifting the k·X samples stored in the sample buffer by a factor X thereby accommodating additional sets of X samples read from the digital decimator per frame. At box 311, the method includes interpolating, by the first interpolator, a single sample received from the primary processing unit by a factor X and outputting X interpolated samples. Finally, at box 311 the method includes mixing, by a mixer, the X interpolated samples with the X digital side tone samples, and outputting the results as X side tone mixed samples.

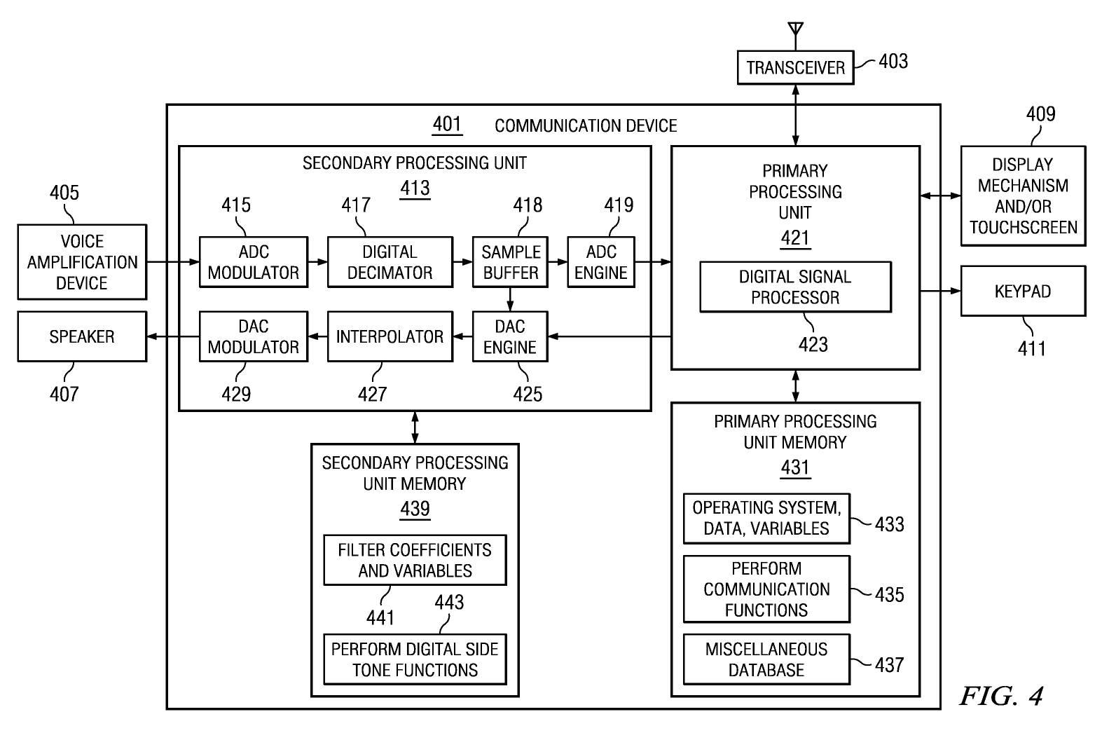

Referring now to FIG. 4, a block diagram illustrating an exemplary communication device for providing digital side tone is discussed and described. FIG. 4 illustrates communication device 401 that includes a primary processing unit 421, a secondary processing unit 413, and the following peripheral components: a transceiver 403, a voice amplification device 405, a speaker 407, a display mechanism 409, and a keypad 411. The communication device further includes a primary processing unit memory 431 and a secondary processing unit memory 439.

The primary processing unit memory 431 may be coupled to the primary processing unit 421 and may comprise a read-only memory (ROM), a random-access memory (RAM), a programmable ROM (PROM), and/or an electrically erasable read-only memory (EEPROM). The primary processing unit memory 431 may include multiple memory locations for storing, among other things, an operating system, data and variables 435 for computer programs executed by the primary processing unit 421. The computer programs cause the primary processing unit 421 to operate in connection with various communication functions 435. The communication functions 435 cause the primary processing unit 421 to undertake communication activity with other communication units and the users of the other communications units. The communication activity referred to above is known in the art and is not detailed herein. The primary processing unit memory 431 additionally includes a miscellaneous database 437 for storing other data not specifically mentioned herein.

The secondary processing unit 413 includes ADC modulator 415, digital decimator 417, sample buffer 418, ADC engine 419, DAC engine 425, interpolator 427, and DAC modulator 429. The components of the secondary processing unit 413 are intended to operate so as to implement a method for providing digital side tone similar to that described in detail above. Additionally, the components of the secondary processing unit 413 are intended to resemble the components of the secondary processing unit 101 illustrated in FIG. 1 and described above related to FIG. 3. Thus the ADC modulator 414 corresponds to the first delta-sigma modulator 103. The digital decimator 417 corresponds to the digital decimator 105. The ADC engine 419 corresponds at least with the first decimator 111 and the second decimator 113. The DAC engine 425 corresponds at least with the first interpolator 115 and the second interpolator 121. The interpolator 427 corresponds with the third interpolator 123. The DAC modulator corresponds with the second delta-sigma modulator 125.

The sample buffer 418 in FIG. 4 corresponds with the sample buffer 107 illustrated in FIG. 1. It should be noted that the ADC engine 419 and the DAC engine 425 may included additional components that aid in digital side tone production but are not illustrated therein. It should additionally be emphasized that in all the included figures, the various types of filters, decimators, interpolators, modulators, and mixers, and the assigned variables associated therewith are exemplary only and are not intended to be limiting, except where the provided claims herein specifically recite otherwise.

The secondary processing unit memory 439 may be coupled to the secondary processing unit 413 and may comprise a read-only memory (ROM), a random-access memory (RAM), a programmable ROM (PROM), and/or an electrically erasable read-only memory (EEPROM). The secondary processing unit memory 431 may include multiple memory locations for storing, among other things, filter coefficients and variables 441 for computer programs executed by the secondary processing unit 421. The computer programs cause the primary processing unit 421 to operate in connection with perform digital side tone functions 443. The perform digital side tone functions 443 cause the secondary processing unit 421 to implement a method for providing digital side tone similar to that described in detail above.

The word “buffer” is used herein means an area of memory used for storing data. It may or may not have other attributes such as an input pointer (where new data will be written into the buffer), and output pointer (where the next item will be read from) and/or a count of the space used or free.

The word “decimation” is used herein to mean a technique for reducing the number of samples in a discrete-time signal. The element which implements this technique is referred to herein as a “decimator.” Decimation may be a two-step process that includes a low-pass anti-aliasing filter and downsampling.

The word “frame” is used herein to mean a group or set of samples acquired and processed periodically over a discrete time period.

The word “interpolation” is used herein to mean a technique for increasing the number of samples in a discrete-time signal. The element which implements this technique is referred to herein as an “interpolator.”

The word “mixer” is used herein to mean a linear/nonlinear or time-invarying/time-varying circuit or device that accepts as its input two signals of the same frequency and presents at its output a mixture of the signals at the same frequency.

The word “reading” is used herein to mean obtaining, acquiring, sampling, and/or processing via known techniques in signal processing.

The phrase “sampling rate” is used herein to mean the rate at which samples of an analog signal are taken in order to be converted into digital form. This phrase may be interchangeable with the phrase “sampling frequency,” as is understood in the art.

As mentioned above, this disclosure is intended to explain how to fashion and use various embodiments rather than to limit the true, intended, and fair scope and spirit of said embodiments. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method for producing digital side tone in a communication device configured with a primary processing unit and a secondary processing unit, comprising
reading X samples output from a digital decimator at a rate equal to an output sampling rate of a first interpolator, storing the X read samples in a sample buffer, and outputting the X read samples as X digital side tone samples to a digital-to-analog converter (DAC);
decimating, by a first decimator, k·X samples stored in the sample buffer by a factor k, and outputting X yielded samples to a second decimator;
decimating, by the second decimator, the X yielded samples, and outputting to the primary processing unit a single sample at a rate equal to the sampling frequency of samples input to the DAC;
discarding k−1 samples for every k samples read by the primary processing unit;
continually shifting the k·X samples stored in the sample buffer by a factor X thereby accommodating additional sets of X samples read from the digital decimator per frame;
interpolating, by the first interpolator, a single sample received from the primary processing unit by a factor X and outputting X interpolated samples; and
mixing, by a mixer, the X interpolated samples with the X digital side tone samples, and outputting the results as X side tone mixed samples,
the secondary processing unit including an analog-to-digital converter (ADC) configured with the digital decimator, the first decimator and the second decimator, the DAC configured with the first interpolator, the sample buffer of length k·X, and the mixer, and
the sampling frequency of samples input to the DAC being an integer multiple k of a sampling frequency of samples read from the ADC and X being the decimator factor of the second decimator

2. The method according to claim 1, wherein
the ADC is further configured with a first delta-sigma modulator programmed with an over sampling ratio (OSR); and the method further comprises
decimating, by the digital decimator, samples received from the first delta-sigma modulator.

3. The method according to claim 2, wherein
the DAC is further configured with a second interpolator, and the method further comprises
interpolating, by the second interpolator the X side tone mixed samples as interpolated side tone mixed samples; and
outputting the interpolated side tone mixed samples from the second interpolator.

4. The method according to claim 3, wherein
the DAC is further configured with a third interpolator, and the method further comprises interpolating, by the third interpolator, the interpolated side tone mixed samples as final digital interpolated side tone mixed samples; and
outputting the final digital interpolated side tone mixed samples from the third interpolator.

5. The method of claim 4, wherein
the DAC is further configured with a second delta-sigma modulator, and the method further comprises
modulating, by the second delta-sigma modulator, the final digital interpolated side tone mixed samples.

6. The method of claim 1, wherein
the ADC is clocked to output samples k times faster than in an environment where digital side tones are not output from the ADC.

7. The method of claim 1, wherein
the primary processing unit reads samples, including the output single sample, in a modulo k logic sequentially from the k·X samples stored in the sample buffer.

8. A communication device capable of producing digital side tone, comprising:
a transceiver;
a primary processing unit cooperatively operable with the transceiver and configured for performing communication functions; and
a secondary processing unit cooperatively operable with the primary processing unit, the secondary processing unit including an analog-to-digital converter (ADC) configured with a first decimator and a second decimator, a digital-to-analog converter (DAC) configured with a first interpolator, a sample buffer of length k·X, and a mixer, a sampling frequency of samples input to the DAC being an integer multiple k of a sampling frequency of samples read from the ADC, and X being the decimator factor of the second decimator, wherein
the ADC is further configured with a digital decimator that outputs X samples at a rate equal to an output sampling rate of the first interpolator, the X read samples being stored in the sample buffer, and the X read samples being output as digital side tone samples to the DAC;
the ADC is configured so that the first decimator decimates k·X samples stored in the sample buffer by a factor k and outputs X yielded samples to the second decimator;
the ADC is configured so that the second decimator decimates the X yielded samples and outputs to the primary processing unit a single sample at a rate equal to the sampling frequency of samples input to the DAC;
the primary processing unit is configured to discard k−1 samples for every k samples it reads from the second decimator;
the sample buffer is configured to continually shift the k·X samples stored in the sample buffer by a factor X thereby accommodating additional sets of X samples read from the digital decimator per frame;
the DAC is configured so that the first interpolator interpolates a single sample received from the primary processing unit by a factor X and outputs X interpolated samples; and
the mixer is configured to mix the X interpolated samples with the X digital side tone samples and to output the results as X side tone mixed samples.

9. The communication device of claim 8, wherein
the ADC is further configured with a first delta-sigma modulator programmed with an over sampling ratio (OSR); and
the digital decimator decimates samples received from the first delta-sigma modulator.

10. The communication device according to claim 9, wherein
the DAC is further configured with a second interpolator that interpolates the X side tone mixed samples as interpolated side tone mixed samples, outputs the interpolated side tone mixed samples.

11. The communication device according to claim 10, wherein
the DAC is further configured with a third interpolator that interpolates the interpolated side tone mixed samples final digital interpolated side tone mixed samples and outputs the final digital interpolated side tone mixed samples.

12. The communication device according to claim 11, wherein
the DAC is further configured with a second delta-sigma modulator that modulates the final digital interpolated side tone mixed samples.

13. The communication device according to claim 8, wherein
the ADC is clocked to output samples k times faster than in an environment where digital side tones are not output from the ADC.

14. The communication device according to claim 8, wherein
the primary processing unit is configured to reads samples, including the output single sample, in a modulo k logic sequentially from the k·X samples stored in the sample buffer.

15. A computer-readable storage medium comprising instructions for execution by a processor, the instructions including a processor-implemented method for producing digital side tone in a communication device with a primary processing unit and a secondary processing unit, the instructions for implementing:
reading X samples output from a digital decimator at a rate equal to an output sampling rate of a first interpolator, storing the X read samples in a sample buffer, and outputting the X read samples as X digital side tone samples to a digital-to-analog converter (DAC);
decimating, in a first decimator, k·X samples stored in the sample buffer by a factor k, and outputting X yielded samples to a second decimator;
decimating, in the second decimator, the X yielded samples, and outputting to the primary processing unit a single sample at a rate equal to the sampling frequency of samples input to the DAC;
discarding k−1 samples for every k samples read by the primary processing unit;
continually shifting the k·X samples stored in the sample buffer by a factor X thereby accommodating additional sets of X samples read from the digital decimator per frame;
interpolating, in a first interpolator, a single sample received from the primary processing unit by a factor X and outputting X interpolated samples; and
mixing, in a mixer, the X interpolated samples with the X digital side tone samples, and outputting the results as X side tone mixed samples,
the secondary processing unit including an analog-to-digital converter (ADC) configured with the digital decimator, the first decimator and the second decimator, the DAC configured with the first interpolator, and the sample buffer of length k·X,
the sampling frequency of samples input to the DAC being an integer multiple k of a sampling frequency of samples read from the ADC and X being the decimator factor of the second decimator.

16. The computer-readable storage medium of claim 15, wherein
the ADC is further configured with a first delta-sigma modulator programmed with an over sampling ratio (OSR), the instructions further implementing
decimating, by the digital decimator, samples received from the first delta-sigma modulator.

17. The computer-readable storage medium of claim 16, wherein
the DAC is further configured with a second interpolator, the instructions further implementing
interpolating, by the second interpolator, the X side tone mixed sample: and\
outputting interpolated side tone mixed samples from the second interpolator.

18. The computer-readable storage medium of claim 17, wherein
the DAC is further configured with a third interpolator, the instructions further implementing
interpolating, by the third interpolator, the side tone mixed samples;
outputting final digital interpolated side tone mixed samples from the third interpolator.

19. The computer-readable storage medium of claim 18, wherein
the DAC is further configured with a second delta-sigma modulator, the instructions further implementing
modulating, by the second delta-sigma modulator, the final digital interpolated side tone mixed samples.

20. The computer-readable storage medium of claim 15, the instructions further implementing
the ADC being clocked to output samples k times faster than in an environment where digital side tones are not output from the ADC.
